(19) United States
(12) Patent Application Publication
(10) Pub. No.: US 2005/0045551 A1
(43) Pub. Date: Mar. 3, 2005

(54) Sterile container and filter unit for a sterile container

(75) Inventors: Mariana Jakab, Tuttlingen (DE); Friedrich-Wilhelm Oertmann, Tuttlingen (DE); Torsten Renner, Eisenberg (DE); Stefan Schuster, Villingen-Schwenningen (DE); Wolfgang Schwanke, Rietheim-Weilheim (DE)

Correspondence Address: LAW OFFICE OF BARRY R LIPSITZ, 755 MAIN STREET, MONROE, CT, 06468, US

(73) Assignee: AESCULAP AG & Co. KG, Tuttlingen (DE)

(21) Appl. No.: 10/921,058

(22) Filed: Aug. 17, 2004

Related U.S. Application Data
(63) Continuation of application No. PCT/EP03/02134, filed on Mar. 1, 2003.

(30) Foreign Application Priority Data
Mar. 6, 2002 (DE) 202 03 984.6
Aug. 27, 2002 (DE) 102 40 597.2

(51) Int. Cl. B01D 35/28

(52) U.S. Cl. 210/436; 210/472; 210/232

(57) ABSTRACT

In order to improve a filter unit for a sterile container, in particular, for accommodating and storing in a sterile manner surgical instruments or material, comprising a receptacle, a lid for closing the receptacle, and a gas exchange opening closable by the filter unit, with the filter unit comprising a sterile filter held by at least one carrier element, such that the danger of contaminating the sterile filter during exchange thereof is reduced, it is proposed that the filter unit comprise at least one grip area separate from the sterile filter for gripping and holding the filter unit, and that the grip area comprise a grip surface. It is further proposed that a sterile container be improved by a filter unit as described hereinabove being provided thereon.

The present disclosure relates to the subject matter disclosed in International Application PCT/EP03/02134 of Mar. 1, 2003, which is incorporated herein by reference in its entirety and for all purposes.

BACKGROUND OF THE INVENTION

The invention relates to a filter unit for a sterile container, in particular, for accommodating and storing in a sterile manner surgical instruments or material, comprising a receptacle, a lid for closing the receptacle, and a gas exchange opening closable by the filter unit, with the filter unit comprising a sterile filter held by at least one carrier element.

The present invention further relates to a sterile container, in particular, for accommodating and storing in a sterile manner surgical instruments or material, comprising an accommodating space formed by a container bottom and container walls, a lid for closing the accommodating space, and a gas exchange opening closable by a filter unit.

Surgical material or instruments, for example, are sterilized and stored in such sterile containers. A gas exchange opening is required in order that superheated steam can enter the sterile container during the sterilizing procedure. However, in order to prevent germs, bacteria or the like from being able to enter the sterile container after the sterilization, the gas exchange opening is already closed before the sterilizing procedure by a sterile filter which permits gas exchange but does not allow any undesired pathogenic organisms to enter the sterile container.

When exchanging the filter units on the sterile container, it has been found disadvantageous that if particular care is not taken, the sterile container may come into contact with fingers and thereby become contaminated during the exchange.

The object of the present invention is, therefore, to so improve a filter unit and a sterile container of the kind described at the outset that the danger of contaminating the sterile filter during exchange thereof is reduced.

### SUMMARY OF THE INVENTION

This object is accomplished with a filter unit of the kind described at the outset, in accordance with the invention, in that the filter unit comprises at least one grip area separate from the sterile filter for gripping and holding the filter unit, and in that the grip area comprises a grip surface.

Owing to the grip area separate from the sterile filter, it is possible for a person to grip and hold the filter unit at the specially provided grip area during exchange thereof. The filter unit can thus be securely gripped at the grip area, which reduces the danger of the person sliding with his fingers onto the sterile filter and contaminating it.

The at least one grip area is preferably arranged on the at least one carrier element. The stability of the filter unit is thereby increased, and, in particular, carrier element and grip area can be of integral construction.

It is expedient for the at least one grip area to comprise a recess arranged on the at least one carrier element. When an operator grips the filter unit at the grip area, the operator's fingers are thus held in the recess, thereby preventing them from slipping off.

In a preferred embodiment of the invention, several grip areas arranged on the at least one carrier element can be provided. This increases the likelihood that if the filter unit is caught accidentally, it will be grasped at one of the grip areas. Moreover, several grip areas make it possible for the filter unit to be gripped at both sides, for example, with two hands, which facilitates exchange of the filter unit.

It is advantageous for the sterile filter to be held in a clamped manner between two carrier elements. In this way, it is protected on both sides at least partially against contact with fingers.

It is expedient for the sterile filter to be undetachably connected, in particular, adhesively joined or welded, to the at least one carrier element. The sterile filter is thereby prevented from being able to fall out. In addition, exchange of the sterile filter is facilitated as it is exchanged as unit with the at least one carrier element. Furthermore, the sterile filter is stabilized by the at least one carrier element, which is advantageous, in particular, with normally used, flexible sterile filters.

In order to protect the sterile filter even more reliably and to additionally increase stability, the two carrier elements can be undetachably connected, in particular, adhesively joined or welded, to each other.

In order that as large a throughput area as possible is formed by the sterile filter, and, at the same time, a safe and stable holding of the sterile filter is ensured, provision may be made for the at least one carrier element to comprise a first, outer holding frame and for the sterile filter to be held on the outer holding frame.

It is expedient for the at least one carrier element to comprise a second, inner holding frame, and for the inner holding frame to be arranged within the first, outer holding frame and connected by connecting elements thereto. Particularly with highly flexible, thin or particularly sensitive sterile filters, the sterile filter is additionally stabilized by this special configuration.

A particularly large throughput area for gas exchange is obtained when the inner and/or outer holding frames are of ring-shaped construction.

Manufacture of a filter unit is particularly simple and cost-effective when the connecting elements comprise radial spokes orientated away from a center of the inner and outer holding frames.

The sterile filter is held even more reliably when the connecting elements of the two carrier elements joined to each other are arranged so as to overlap in a direction perpendicular to a plane defined by the sterile filter. A particularly stable holding of the sterile filter is thereby obtained with the sterile filter being held on both sides between both carrier elements in the area of the connecting elements. Furthermore, the throughput area of the sterile filter for gas exchange is maximized.

Furthermore, it may also be advantageous for the connecting elements of the two carrier elements joined to each other to be arranged so as to be rotated relative to one another about an axis of rotation orientated parallel to a direction perpendicular to a plane defined by the sterile filter. The throughput area through the sterile filter is thereby somewhat reduced, but the stability of the filter unit is increased as it is not so easy to push a finger through the sterile filter if it accidentally slips off while holding the filter unit. The connecting elements form barriers for fingers, which are not damageable.

It is expedient for the connecting elements, which are arranged so as to be rotated relative to one another, of the two carrier elements which are joined to each other, to be offset relative to one another through an angle of rotation resulting from the quotient between 360° and twice the number of the connecting elements. All the connecting elements of the filter unit thus serve as stabilizer for the sterile filter, whereas with an overlapping arrangement of the connecting elements only half the number of the connecting elements contributes towards stabilizing the filter unit.

In order that the filter unit can be gripped particularly securely, it is expedient for the at least one grip area to be arranged on the outer and/or the inner holding frame.

In order to prevent fingers from slipping unintentionally off onto the sterile filter, it may be advantageous for the outer and/or the inner holding frame to have a frame width in radial direction, and for the at least one grip area to have a grip area width in radial direction, which is larger at least in sections thereof than the frame width of sections of the outer and/or the inner holding frame adjoining the grip area. The grip area which is thus widened in relation to adjacent sections of the holding frame enables secure gripping of the filter unit, whereby the danger of contaminating or damaging the sterile filter is reduced.

To make it even more difficult for fingers to slip off the grip area, the at least one grip area may comprise a finger retaining element. The finger retaining element holds back fingers which could slide off the grip area. The finger retaining element thus forms in an optional way a barrier for a finger.

The finger retaining element preferably comprises a rim surrounding the grip surface of the grip area. A finger grasping the grip surface of the grip area will be prevented by the rim surrounding the grip surface at least in sections thereof from sliding off the grip surface.

A structured and/or roughened grip surface can provide a particularly good hold.

The object set forth at the outset is accomplished with a sterile container of the kind described at the outset, in accordance with the invention, in that the filter unit comprises one of the inventive filter units described hereinabove.

By the sterile container being provided with such a filter unit, the danger of contaminating or damaging the filter unit is reduced, so that there is an overall improvement in the functionality of the sterile container. The danger of germs or pathogenic organisms entering the interior of the sterile container after sterilization is reduced.

The following description of preferred embodiments of the invention serves in conjunction with the drawings to explain the invention in greater detail.

### BRIEF DESCRIPTION OF THE DRAWINGS

FIG. 1 shows a perspective view of a sterile container;

FIG. 2 shows a partial cross-sectional view through a lid of the sterile container taken along line 2-2 of FIG. 1;

FIG. 3 shows a perspective view of a first embodiment of a filter unit; and

FIG. 4 shows a perspective view of a second embodiment of a filter unit.

### DETAILED DESCRIPTION OF THE INVENTION

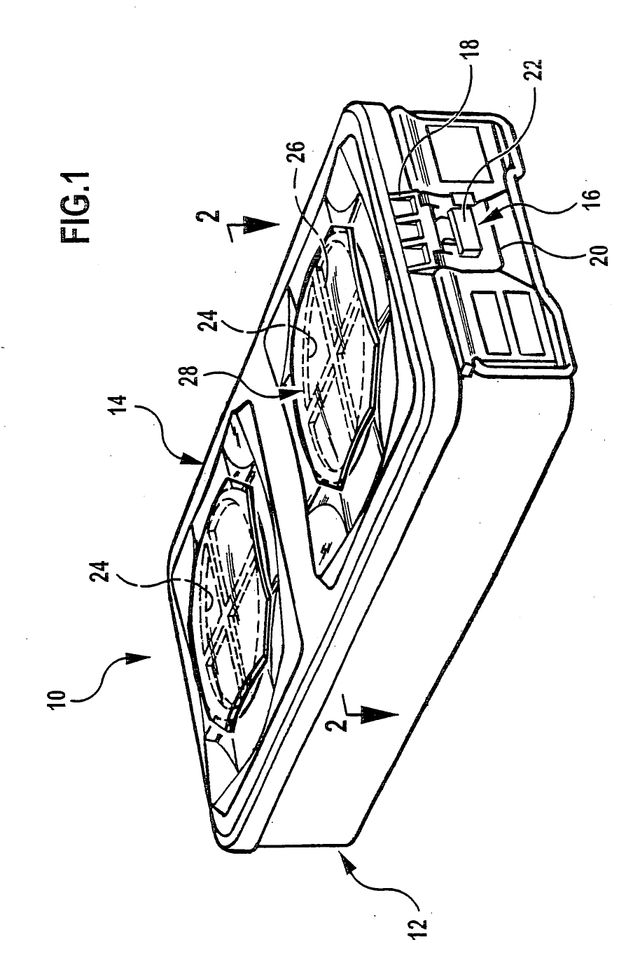

FIG. 1 shows a sterile container generally denoted by reference numeral 10, with a tray 12 for accommodating, for example, surgical instruments or material and with a lid 14 closing the tray 12.

The lid 14 is connectable to the tray 12 via two closures 16 each arranged at an end face. Each closure comprises a bearing block 18 arranged on the end face of the lid 14, and a bracket 20 pivotably mounted on the bearing block 18. In a locked state, as shown in FIG. 1, the bracket 20 embraces a locking projection 22 arranged on the tray 12.

To enable an exchange of gas between an environment and the interior of the sterile container 10, two substantially round ventilation openings 24, which are spanned by two intersecting cross-members 26, are symmetrically arranged in the lid.

On an outer side of the lid 14, each of the two ventilation openings 24 is completely covered by a protective cover 28.

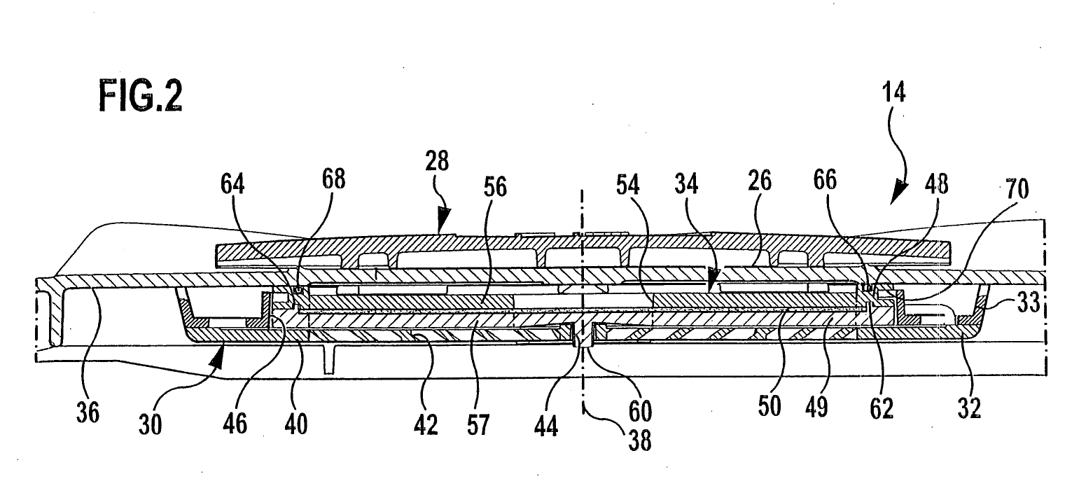

The sectional view in FIG. 2 shows a filter cassette 30 which completely covers the ventilation opening 24 in the interior of the lid 14 and comprises a half dish-type filter housing 32 with a filter unit 34 mounted therein. The filter housing 32 comprises a ring-shaped filter housing frame 33 held in a spring-biased manner in the direction towards the lid 14 for receiving the filter unit 34. The filter housing frame 33 is covered on a side facing away from the underside 36 of the lid with a bottom 40, so that a flat, cylindrical filter receptacle 46 open in the direction towards the underside 36 of the lid is formed by the two parts. The filter cassette 30 is of substantially symmetrical configuration in relation to an axis of symmetry oriented perpendicularly to the lid 14. The bottom 40 is provided with longitudinal slots 42 extending at an incline to the bottom 40 and forming through-openings and with a central bore 44.

The filter unit 34 comprises two clamping discs, namely an upper clamping disc 48 facing the underside 36 of the lid and a lower clamping disc 49, between which a disc-shaped, flat sterile filter is held, for example, a PTFE filter usable as permanent filter.

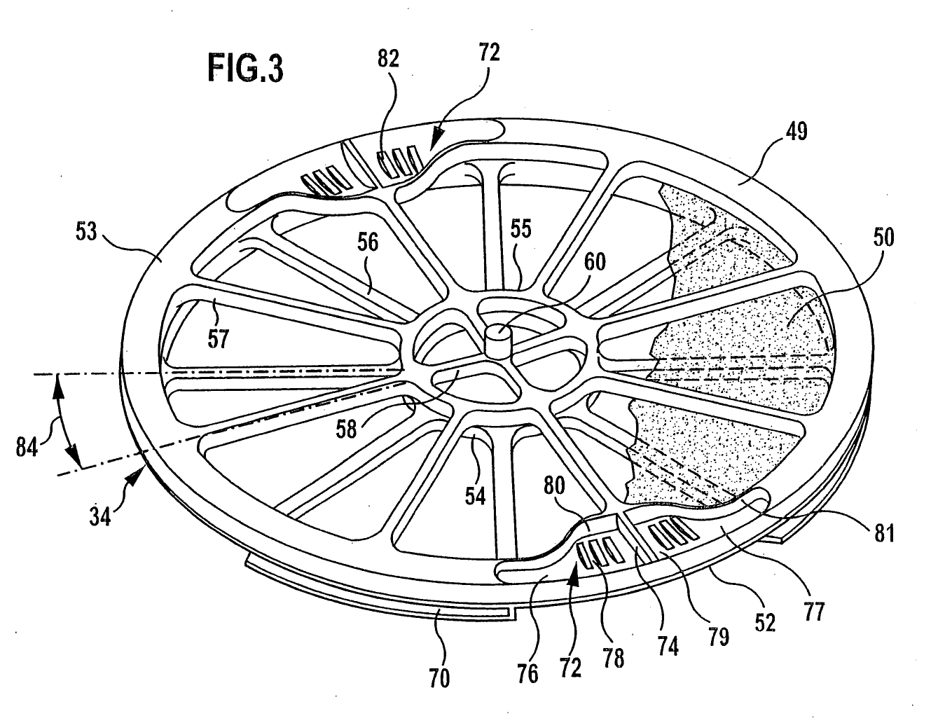

As shown in FIGS. 2 and 3, each of the two clamping discs 48 and 49 comprises an outer clamping ring 52 and 53, respectively, and an inner clamping ring, 54 and 55, respectively, which are connected to one another by eight radially extending spokes 56 and 57, respectively. In addition, a cross-member assembly 58 comprising two intersecting cross-members is disposed in the interior of the inner clamping ring 55 of the lower clamping disc 49 for stabilizing purposes. At the center thereof, the cross-member assembly 58 carries a cylindrical centering pin 60 pointing away from the underside 36 of the lid.

To join the lower clamping disc 49 to the upper clamping disc 48, the upper clamping disc 48 is provided with an annular groove 62 in which an annular projection 64 pointing in the direction towards the underside 36 of the lid engages. A sealing ring 68 is inserted in a further annular groove of the upper clamping disc, which is open in the direction towards the underside 36 of the lid. The upper clamping disc 48 and hence the entire filter cassette 30 is sealed off from the underside 36 of the lid with the sealing ring 68.

A bayonet connection is provided between the filter housing frame 33 and the upper clamping disc for joining the filter unit 34 to the filter housing 32. To this end, the upper clamping disc 48 has several radially outwardly open bayonet grooves 70 along its circumference, in which a corresponding radially inwardly oriented projection on the filter housing frame 33 can engage.

Furthermore, two diametrically opposed grip areas 72 are formed on the filter unit 34, more specifically, on the outer clamping ring 53 of the lower clamping disc 49. Each grip area 72 symmetrically adjoins a spoke 57 and is formed symmetrically in relation thereto. An extension 74 of the spoke 57 separates two recesses 76 and 77 from each other. The recesses 76 and 77 carry in the bottom thereof a grip surface 78 and 79, respectively, and a rim 80 and 81, respectively, rising in the form of a projection from the respective grip surface 78 and 79, respectively. Each of the two grip surfaces 78 and 79 is additionally provided with a ribbed structure 82. The grip surface 78 and 79 may also be roughened or structured in any other form instead of having the ribbed structure 82.

The recesses 76 and 77 have at their end pointing away from the extension 74 a width which is slightly smaller than the width of the outer clamping ring 53 in radial direction. In the direction towards the extension 74 the grip surface 78 and 79, respectively, widens at one side in the direction towards the axis of symmetry 38. It is delimited by the rim 80 at least on its side facing in the direction towards the axis of symmetry 38, but can also be completely surrounded by the rim 80. In particular, the rim 80 serves as finger retaining element to prevent fingers engaging the recesses 76 and 77, respectively, from sliding off onto the sterile filter 50.

The filter cassette 30 is assembled by the filter unit 34 being gripped with fingers at the grip areas 72 and inserted in the direction of the axis of symmetry 38 into the filter housing frame 33 already mounted on the lid 14 and subsequently rotated about the axis of symmetry 38. The filter unit 34 is held on the filter housing frame 33 by the bayonet connection. Finally, the bottom 40 with its bore 44 is pushed over the centering pin 60 and connected to further locking projections in the area of adjacent surfaces between the bottom 40 and the filter housing frame 33.

In the embodiment of a filter unit 34 shown in FIG. 3, the two clamping discs 48 and 49 are joined to each other in such a way that the spokes 56 and 57 are offset relative to each other through an angle of rotation 84 of 22.5°. Thus the sterile filter 50 is not clamped between two spokes 56 and 57, but lies alternately on one of the two spokes 56 and 57, respectively. The sterile filter is additionally protected against damage by this relative orientation of the spokes 56 and 57 to each other, for at a spacing of 22.5° one of the spokes 56 or 57 respectively protects the sterile filter against having something pushed through it, should a person or an object grasp or touch the filter unit 34.

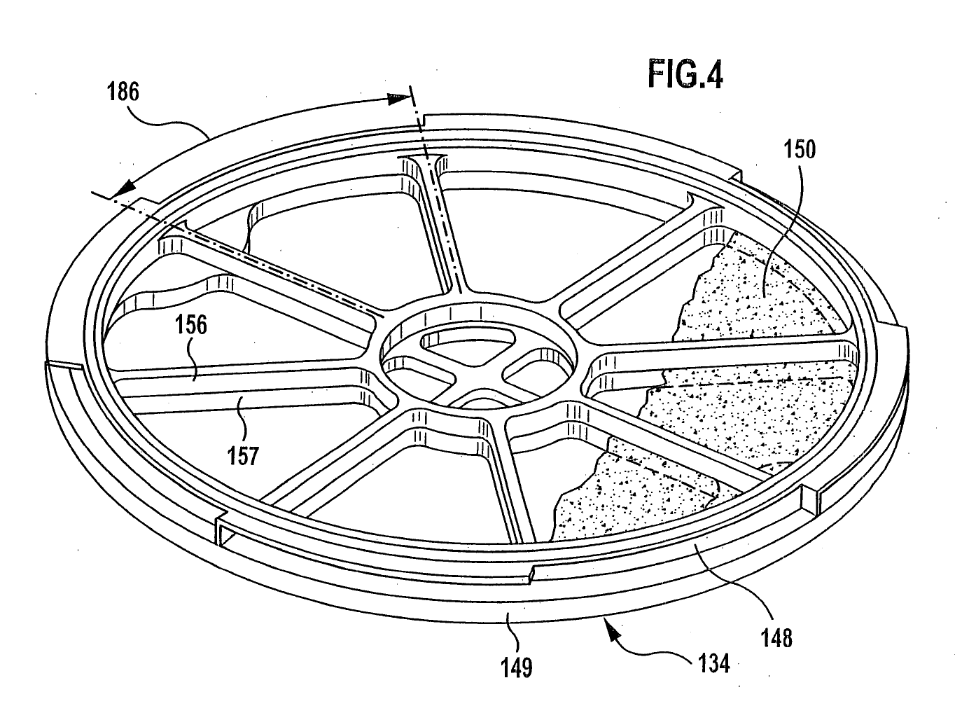

FIG. 4 shows a second embodiment of a filter unit generally denoted by the reference numeral 134, in which like parts are denoted by like reference numerals with a prefixed 1. The filter units 34 and 134 differ in that with the filter unit 134 the spokes 156 and 157 are arranged so as to overlap one another, with the spacing between the spokes 156 and 157 corresponding to a spoke angle 186 of 45°. Thus, the sterile filter 150 is additionally clamped between two spokes 156 and 157, with the free area between neighboring spokes 156 being twice as large as with the filter unit 34.

1. Filter unit for a sterile container, in particular, for accommodating and storing in a sterile manner surgical instruments or material, comprising a receptacle, a lid for closing the receptacle, and a gas exchange opening closable by the filter unit,
said filter unit comprising a sterile filter held by at least one carrier element, and at least one grip area separate from the sterile filter for gripping and holding the filter unit, and
said grip area comprising a grip surface.

2. Filter unit in accordance with claim 1, wherein the at least one grip area is arranged on the at least one carrier element.

3. Filter unit in accordance with claim 1, wherein the at least one grip area comprises a recess arranged on the at least one carrier element.

4. Filter unit in accordance with claim 1, wherein several grip areas arranged on the at least one carrier element are provided.

5. Filter unit in accordance with claim 1, wherein the sterile filter is held in a clamped manner between two carrier elements.

6. Filter unit in accordance with claim 1, wherein the sterile filter is undetachably connected to the at least one carrier element.

7. Filter unit in accordance with claim 6, wherein the sterile filter is adhesively joined or welded to the at least one carrier element.

8. Filter unit in accordance with claim 5, wherein the two carrier elements are undetachably connected to each other.

9. Filter unit in accordance with claim 8, wherein the two carrier elements are adhesively joined or welded to each other.

10. Filter unit in accordance with claim 1, wherein the at least one carrier element comprises a first, outer holding frame, and the sterile filter is held on the outer holding frame.

11. Filter unit in accordance with claim 10, wherein the at least one carrier element comprises a second, inner holding frame, and the inner holding frame is arranged within the first, outer holding frame and is connected thereto by connecting elements.

12. Filter unit in accordance with claim 10, wherein the inner and/or outer holding frames are of ring-shaped construction.

13. Filter unit in accordance with claim 11, wherein the connecting elements comprise radial spokes orientated away from a center of the inner and outer holding frames.

14. Filter unit in accordance with claim 11, wherein the connecting elements of the two carrier elements joined to each other are arranged so as to overlap one another in a direction perpendicular to a plane defined by the sterile filter.

15. Filter unit in accordance with claim 11, wherein the connecting elements of the two carrier elements joined to each other are arranged such that they are rotated relative to one another about an axis of rotation orientated parallel to a direction perpendicular to a plane defined by the sterile filter.

16. Filter unit in accordance with claim 15, wherein the connecting elements, which are arranged so as to be rotated relative to one another, of the two carrier elements which are joined to each other, are offset relative to one another through an angle of rotation resulting from the quotient between 360° and twice the number of the connecting elements.

17. Filter unit in accordance with claim 10, wherein the at least one grip area is arranged on the outer and/or the inner holding frame.

18. Filter unit in accordance with claim 10, wherein the outer and/or the inner holding frame have a frame width in radial direction, and the at least one grip area has a grip area width in radial direction, which is larger at least in sections thereof than the frame width of sections of the outer and/or the inner holding frame adjoining the grip area.

19. Filter unit in accordance with claim 1, wherein the at least one grip area comprises a finger retaining element.

20. Filter unit in accordance with claim 19, wherein the finger retaining element comprises a rim surrounding the grip surface of the grip area.

21. Filter unit in accordance with claim 1, wherein the grip surface is structured and/or roughened.

22. Sterile container, in particular, for accommodating and storing in a sterile manner surgical instruments or material, comprising an accommodating space formed by a container bottom and container walls, a lid for closing the accommodating space, and a gas exchange opening closable by a filter unit,
said filter unit comprising a sterile filter held by at least one carrier element, and at least one grip area separate from the sterile filter for gripping and holding the filter unit, and
said grip area comprising a grip surface.
